(19) United States
(12) Patent Application Publication
(10) Pub. No.: US 2004/0213865 A1
(43) Pub. Date: Oct. 28, 2004

(54) Discharge device of an extruding installation

(76) Inventors: Joachim Graefe, Schwerte (DE); Uwe Muschalik, Duisburg (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/469,503

(22) PCT Filed: Feb. 21, 2002
(86) PCT No.: PCT/DE01/00629

(30) Foreign Application Priority Data
Mar. 2, 2001 (DE) 101 10 035.3

(51) Int. Cl. B29C 53/08

(52) U.S. Cl. 425/3; 425/392

(57) ABSTRACT

The invention relates to a discharge device of an extruding installation (1), particularly provided for producing curved extruded products, that comprises, on a table-like support (8), a channel (7) which accommodates the extruded product. Said channel (7) is provided in the form of a flexible component that can be swung outward from the straight extruding direction (4) thereof.

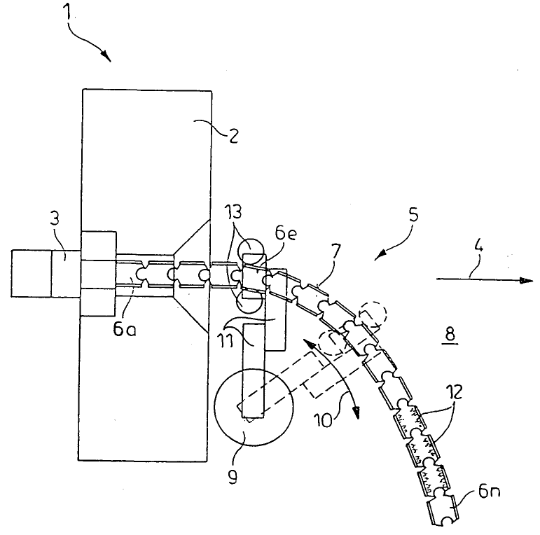

The invention relates to a discharge device for an extruder, in particular for producing a curved extrusion, that has a table-like support carrying a channel that receives the extrusion.

It is known in a bar or tube extruder or a combined bar/tube extruder to set up the discharge device so it is dependent on the production program. Thus in the extrusion of bars, profiles tubes, and hollow profiles the devices are set up for straight-line extrusion whereas in the production of wire the extruder has a windup spool. In the production of bars with straight-line extrusion there is downstream of the counter beam a nondriven roller conveyor. With a spool winder the roller conveyor is moved to the side in order to make room for a wire feed channel. To this end there is connected a driven lowerable roller conveyor with cast plates between the driven lowerable rollers. In order to feed the extrusion between the rollers and thus to plastically deform it, the rollers are dropped after the extrusion and as a result the extrusion is set down on the plates or on the support table. From this position the discharge transport is standard.

In order to produce the curved or bent extruded profiles, typically of aluminum, required in various industrial settings for various purposes it is known from EP 0,706,843 in extruders of hollow extrusions with wide variance in wall thicknesses to exert by means of a pusher a force at a predetermined distance from the die outlet or counter beam on the strand such that there is an effect on the profile exiting from the extruder die. The pusher can be a pusher roller, a transversely effective slide surface, or even a roller cage. Regardless what kind of pusher is used, a space must be left for return action so that the extrusion can immediately or almost immediately after being extruded and bent or curved and in this manner the extrusion cross section produced by the extruder die does not move parallel to the die but at an angle thereto.

It is an object of the invention to produce in an extruder of the above-described type in a simple manner a variable drive capable of producing arcuate extrusions.

This object is attained according to the invention in that the channel is flexible and can be pivoted out of a position parallel to the extrusion direction. In order to form curved or bent extrusions, one therefore no longer needs a guide tool spaced an exact distance form the counter beam or the die, because the flexible channel is shaped according to the extent of lateral displacement of the strand. In this manner there is no problem retrofitting an existing extruding system with a normal discharge device for straight-line extrusion.

An extruder equipped with the flexible channel according to the invention is as a result ideal to use to form extrusions extruded in a straight line from the extruder as well as arcuate extrusions. In addition the flexible and deflectable channel makes it possible to form for example brass wire which can be temporary deflected to allow use of a windup spool.

According to a preferred embodiment of the invention, the channel is formed of individual channel segments like an open-link chain. In this manner the channel, as well as an alternative one made of one piece of flexible bendable material, can assume various radii of curvature including very small ones. To this end a preferred or selected sizing of the members or segments of the channel is provided.

According to an embodiment of the invention the channel is connected to a manipulating robot. This can be a multiaxis robot that can reach the entire length of the channel with a grab arm and thus allow flexible positions to be set because each individual channel segment can be set and made to conform to the preselected bending radius.

When the channel segments are magnetically arrestable, e.g. by means of a supervisory controller and an on/off switchable electromagnet, after turning off the magnetic clamping the path of the channel—straight or bent—can be set according to the desired parameters and locked in by turning the magnets back on. Alternatively, known mechanical latch or lock means can be used for the segments needing to be fixed.

According to a further proposal of the invention at least some of the channel segments are cooled. Switchable water, water-vapor, and/or air nozzles in the segment walls can influence the bendability as well as the crystalline structure of the extrusion.

Further features and particularities of the invention are seen in the claims and in the following description of an embodiment of the invention illustrated schematically in a single FIGURE.

An extruder 1 shown in top view has a counter beam 2 with a tool support 3 and an output 5 directed in an extruding direction shown by arrow 4.

Extending right up to the tool support 3 is a flexible channel 7 formed like a open-link chain of individual channel segments 6a to 6n. It lies on a table 8 of the output 5 and is pivoted out from the extrusion direction 4 in order to produce a curved or bent extrusion, starting in the embodiment at the channel segment 6e at the counter beam 2 and thereafter to the channel segment 6n.

The flexible channel 7 is bent to different radii by a multiaxis manipulating robot 9 that has a manipulating arm 11 that reaches as shown by double-headed arrow 10 along the length or the arc of the channel 7 from the channel segment 6e to the last channel segment 6n. The channel segments 6a to 6n having schematically indicated integrated coolers 12 are gripped inside and outside by rollers 13 on the manipulating arm 11 in order to change their positions.

1. A discharge device for an extruder, in particular for making an arcuate extrusion that is extruded into a channel receiving the extrusion and supported on a table, characterized in that the channel (7) is flexible and can be deflected out of a position parallel to the straight extrusion direction (4).

2. The discharge device according to claim 1, characterized in that the channel (7) is formed of individual channel segments (6a to 6n) like an open-link chain.

3. The discharge device according to claim 1, characterized in that the channel (7) is connected to a manipulating robot (9).

4. The discharge device according to claim 2, characterized in that the channel segments (6a to 6n) are magnetically arrestable.

5. The discharge device according to claim 1, characterized in that at least some of the channel segments (6a to 6n) are cooled.
